(19) United States
(12) Patent Application Publication
(10) Pub. No.: US 2008/0051131 A1
(43) Pub. Date: Feb. 28, 2008

(54) Method and system for transporting FM data over a Bluetooth HCI link

(76) Inventors: Brima Ibrahim, Aliso Viejo, CA (US); Mitchell Buznitsky, Pinabete, CA (US); Angel Polo, San Diego, CA (US); John Walley, Ladera Ranch, CA (US)

Correspondence Address: MCANDREWS HELD & MALLOY, LTD, 500 WEST MADISON STREET, SUITE 3400, CHICAGO, IL, 60661, US

(21) Appl. No.: 11/508,625

(22) Filed: Aug. 23, 2006

(51) Int. Cl. H04B 7/00; H04M 1/00

(52) U.S. Cl. 455/552.1; 455/41.2

(57) ABSTRACT

Certain aspects of a method and system for transporting FM data over a Bluetooth HCI link may comprise processing FM signals in a single chip that comprises integrated Bluetooth and FM radios. The processed signals may be communicated to a host communicatively coupled via the HCI. The processed signals may comprise samples of the left and right channels of the analog baseband FM signal. The processed signals may be communicated to the host via a L2CAP connection over the HCI. Each L2CAP packet may comprise alternating left then right channel samples. Or the samples of one channel may be placed before the samples of the other channel. The number of samples for one channel may be the same as the number of samples for the other channel in each L2CAP packet. Furthermore, the samples in the L2CAP packets may be compressed.

### CROSS-REFERENCE TO RELATED APPLICATIONS/INCORPORATION BY REFERENCE

This application makes reference to, claims priority to, and claims benefit of U.S. application Ser. No. 11/286,555 (Attorney Docket No. 16663US02) filed on Nov. 22, 2005. The above stated application is hereby incorporated herein by reference in its entirety.

### FIELD OF THE INVENTION

Certain embodiments of the invention relate to wireless communication technologies. More specifically, certain embodiments of the invention relate to a method and system for transporting FM data over a Bluetooth HCI link.

### BACKGROUND OF THE INVENTION

With the popularity of portable electronic devices and wireless devices that support audio applications, there is a growing need to provide a simple and complete solution for audio communications applications. For example, some users may utilize Bluetooth-enabled devices, such as headphones and/or speakers, to allow them to communicate audio data with their wireless handset while freeing to perform other activities. Other users may have portable electronic devices that may enable them to play stored audio content and/or receive audio content via broadcast communication, for example.

However, integrating multiple audio communication technologies into a single device may be costly. Combining a plurality of different communication services into a portable electronic device or a wireless device may require separate processing hardware and/or separate processing software. Moreover, coordinating the reception and/or transmission of data to and/or from the portable electronic device or a wireless device may require significant processing overhead that may impose certain operation restrictions and/or design challenges.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for transporting FM data over a Bluetooth HCI link, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of exemplary mobile terminals with Bluetooth and FM radios that receive FM transmissions, which may be utilized in connection with an embodiment of the invention.

FIG. 2 is a block diagram illustrating an exemplary Bluetooth enabled mobile terminal, in accordance with an embodiment of the invention.

FIG. 3A is a block diagram of an exemplary Bluetooth controller with integrated Bluetooth and FM radios that supports Bluetooth and FM operations, in accordance with an embodiment of the invention.

FIG. 3B is a block diagram of an exemplary Bluetooth controller with integrated Bluetooth and FM radios that supports multiple interfaces, in accordance with an embodiment of the invention.

FIG. 4 is a diagram of an ACL data packet, which may be utilized in connection with an embodiment of the invention.

FIG. 5 is a diagram of a L2CAP data packet, which may be utilized in connection with an embodiment of the invention.

FIG. 6 is a flow diagram that illustrates exemplary steps for initiating transfer of digital baseband FM data via the HCI link, in accordance with an embodiment of the invention.

FIG. 7A is a flow diagram that illustrates exemplary steps for communicating digital baseband FM data via the HCI link, in accordance with an embodiment of the invention.

FIG. 7B is a flow diagram that illustrates exemplary steps for converting received FM signals to digital baseband FM data, in accordance with an embodiment of the invention.

### DETAILED DESCRIPTION OF THE INVENTION

Certain embodiments of the invention may be found in a method and system for transporting FM data over a Bluetooth host-controller interface (HCI) link. Aspects of the invention may comprise processing received FM signals in a single chip comprising an integrated Bluetooth radio, an integrated FM radio, and a HCI. Although HCI may be a protocol, for simplicity, the term HCI may also be used to refer to a physical interface that may be used with the HCI protocol. The HCI protocol may be used with or without a physical interface. HCI may refer to a physical interface that links a Bluetooth controller to a Bluetooth host and/or to circuitry that may drive signals on to the physical interface. The processed received FM signals, may comprise digital baseband signals, or digital baseband FM signals, which may be communicated to a host that may be communicatively coupled to the single chip via a HCI link. The digital baseband signals may comprise samples for the left and right channels of an analog baseband FM signal. The sampling rate for the analog baseband FM signal may be greater than twice the 15 KHz bandwidth of the analog baseband FM signal. The sampling rate used may be design and/or implementation dependent.

The digital baseband FM signal may be communicated to the host via a L2CAP connection over the HCI link. The left channel signal samples and the right channel signal samples may be placed in each L2CAP packet, either alternating, or where samples of one channel are followed by samples of the other channel. The host device may be notified as to an order in which the left channel samples and the right channel samples are loaded in the L2CAP packet. For example, the host may be notified as to whether the alternating samples start with the right channel sample or the left channel sample, or whether the left or right channel samples are placed first in each L2CAP packet. The number of samples for the left channel may be the same as the number of samples for the right channel in each L2CAP packet. Furthermore, the samples in the L2CAP packets may be compressed within the single chip with integrated Bluetooth radio and FM radio.

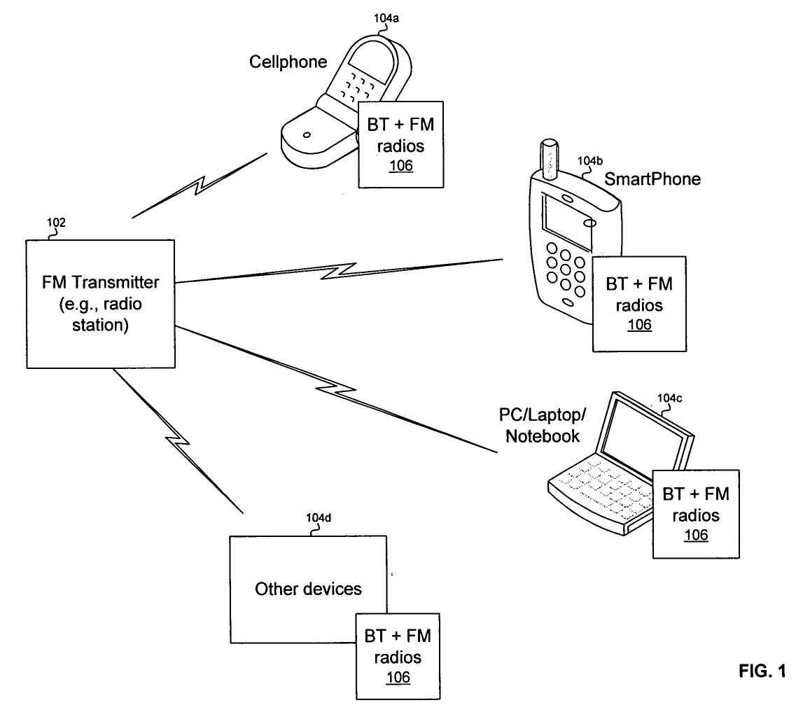

FIG. 1A is a block diagram of exemplary mobile terminals with Bluetooth and FM radios that receive FM transmissions, which may be utilized in connection with an embodiment of the invention. Referring to FIG. 1A, there is shown an FM transmitter 102 and mobile terminals, such as, for example, a cellular phone 104a, a smart phone 104b, a computer 104c, and an exemplary FM and Bluetooth-equipped device 104d. The FM transmitter 102 may be implemented as part of a radio station or other broadcasting device, for example. Each of the cellular phone 104a, the smart phone 104b, the computer 104c, and the exemplary FM and Bluetooth-equipped device 104d may comprise Bluetooth and FM radios 106 for supporting FM and Bluetooth data communications.

The cellular phone 104a may be enabled to receive FM transmission via the Bluetooth and FM radios 106 from the FM transmitter 102. The user of the cellular phone 104a may then listen to the transmission via a speaker in the cellular phone 104a. The smart phone 104b may be enabled to receive FM transmission via the Bluetooth and FM radios 106 from the FM transmitter 102. The user of the smart phone 104b may then listen to the transmission via a speaker in the smart phone 104b.

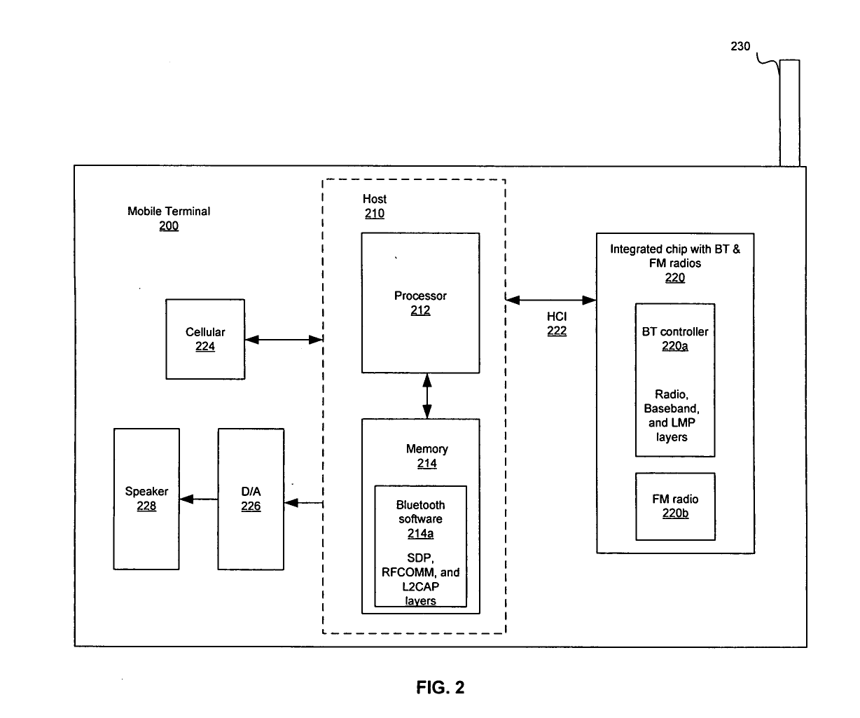

The computer 104c may be a desktop, laptop, notebook, tablet, and a PDA, for example. The computer 104c may be enabled to receive FM transmission via the F Bluetooth and FM radios 106 from the FM transmitter 102. The user of the computer 104c may then listen to the transmission via a speaker in the computer 104c. Similarly, other FM and Bluetooth-equipped device 104d may be enabled to receive FM transmission via the Bluetooth and FM radios 106 from the FM transmitter 102. The user of the FM and Bluetooth-equipped device 104d may then listen to the transmission via a speaker that may be built in to the FM and Bluetooth-equipped device 104d. Information in the FM broadcast may be communicated from the Bluetooth and FM radios 106 to a Bluetooth host in each device via a host-controller interface (HCI) link. This may be explained in more detail with respect to FIGS. 2, 3A, 3B, 4, 5, 6, 7A, and 7B.

FIG. 2 is a block diagram illustrating an exemplary Bluetooth enabled mobile terminal, in accordance with an embodiment of the invention. Referring to FIG. 2, there is shown a mobile terminal 200, which may be one of the mobile terminals 104a, 104b, 104c, or 104d. The mobile terminal 200 may comprise a host 210, an integrated chip with Bluetooth and FM radios (BT-FM chip) 220, a host-controller interface (HCI) 222, a cellular block 224, a digital-to-analog converter (DAC) 226, at least one speaker 228, and an antenna 230. The host 210 may comprise a processor 212 and memory 214. Bluetooth software 214a may be stored in the memory 214, where the Bluetooth software 214a may comprise higher layers of Bluetooth protocol. The higher layers may comprise, for example, logical link control and adaptation protocol (L2CAP), RFCOMM protocol, and service discovery protocol (SDP).

The SDP layer may provide a means for applications to discover which services may be provided by or may be available through a Bluetooth device. It may also allow applications to determine the characteristics of those available services, such as, for example, a service class for a specific service. The RFCOMM protocol may provide emulation of RS232 serial ports over the L2CAP. For example, the RFCOMM may allow support of up to 60 simultaneous connections between two Bluetooth devices. The number of connections that may be used simultaneously in a Bluetooth device may be implementation-specific. With respect to RFCOMM, a complete communication path may involve two applications running on different devices (the communication endpoints) with a communication segment between them. The RFCOMM protocol may accommodate two types of Bluetooth devices. Type 1 devices may be communication end points such as computers and printers. Type 2 devices may be those that are part of the communication segment, such as, for example, modems.

The L2CAP layer supports higher-level protocol multiplexing, packet segmentation and reassembly, and the conveying of quality of service information. Accordingly, the L2CAP layer provides connection-oriented and connectionless data services to upper layer protocols with protocol multiplexing capability, segmentation and reassembly operation, and group abstractions. L2CAP permits higher-level protocols and applications to transmit and receive L2CAP data packets, where each packet may be up to 64 kilobytes in length.

The processor 212 may comprise suitable logic, circuitry, and/or code that may enable control and/or management operations in at least portions of the mobile terminal 200. In this regard, the processor 212 may communicate control and/or management operations to the host 210 and the BT-FM chip 220. Moreover, the processor 212 may be utilized to process data received by the mobile terminal 200 and/or to process data to be transmitted by the mobile terminal 200.

The memory 214 may comprise suitable logic, circuitry, and/or code that may enable storing of data and code, and reading of the stored data and the code. For example, the Bluetooth software 214a may be stored in the memory 214. The Bluetooth software 214a may be executed by the processor 212 to process the data received from the BT-FM chip 220. The Bluetooth software 214a may also be used to process data to communicate to the BT-FM chip 220, which may then transmit the data to other Bluetooth devices.

The BT-FM chip 220 may comprise a Bluetooth controller 220a and a FM radio 220b. U.S. application Ser. No. 11/286,555 (Attorney Docket No. 16663US02) filed on Nov. 22, 2005, provides an exemplary communication system that utilizes a single chip integrated Bluetooth and FM transceiver and baseband processor and is hereby incorporated herein by reference in its entirety.

The Bluetooth controller 220a may comprise suitable logic, circuitry, and/or code that may enable Bluetooth transmission of data to other Bluetooth devices and reception of Bluetooth transmission from other Bluetooth devices. The Bluetooth controller 220a may also enable communication of data to and from the host 210. The Bluetooth controller 220a may comprise lower layers of the Bluetooth protocol, such as, for example, link manager protocol (LMP) layer, baseband layer, and the radio layer. A link manager on each Bluetooth device may use the LMP to set up and control communication links. The baseband layer is the physical layer of the Bluetooth protocol. It is used to manage physical channels and links apart from other services like error correction, data whitening, hop selection and Bluetooth security. The baseband layer is above the radio layer in the Bluetooth protocol stack. The baseband layer is implemented as a Link Controller, which works with the link manager for carrying out link level routines like link connection and power control. The baseband layer also manages asynchronous and synchronous links, handles packets and does paging and inquiry to access and inquire Bluetooth devices in the area. The bottommost layer, the radio layer, defines the requirements for a Bluetooth transceiver operating in the 2.4 GHz ISM band.

The Bluetooth controller 220a may process the received signals and communicate the processed signals to the host 210. The Bluetooth controller 220a may also enable transmitting Bluetooth signals to other Bluetooth devices. The Bluetooth controller 220a may process signals received from the host 210 before transmission to other Bluetooth devices. The host 210 and the Bluetooth controller 220a may communicate with each other via one or more links over the HCI 222.

The FM radio 220b may comprise suitable logic, circuitry, and/or code that may enable reception of FM transmission, such as, for example, commercial FM radio broadcast. The cellular block 224 may comprise suitable logic, circuitry, and/or code that may enable wireless communication via, for example, a cellular network (not shown).

In operation, a user of the mobile terminal 200, which may be, for example, a Bluetooth enabled cellular phone that can also receive FM broadcasts, may receive FM signals from an FM radio station (not shown). The FM radio 220b may process the received FM signals to a digital baseband FM data. The digital baseband FM data may be communicated to the Bluetooth controller 220a. The Bluetooth controller 220a may then communicate the digital baseband FM data to the host 210 using data packets on an asynchronous connectionless link (ACL) over the HCI 222. The host 210 may execute the Bluetooth software 214a to receive and process the digital baseband FM data from the BT-FM chip 220. For example, the host 210 may receive asynchronous connectionless link (ACL) data packets from the BT-FM chip 220, and may process the packets, which may comprise music. The processing may comprise converting the digital data to analog data via the DAC 226, for example, in order to play music via at least one speaker 228.

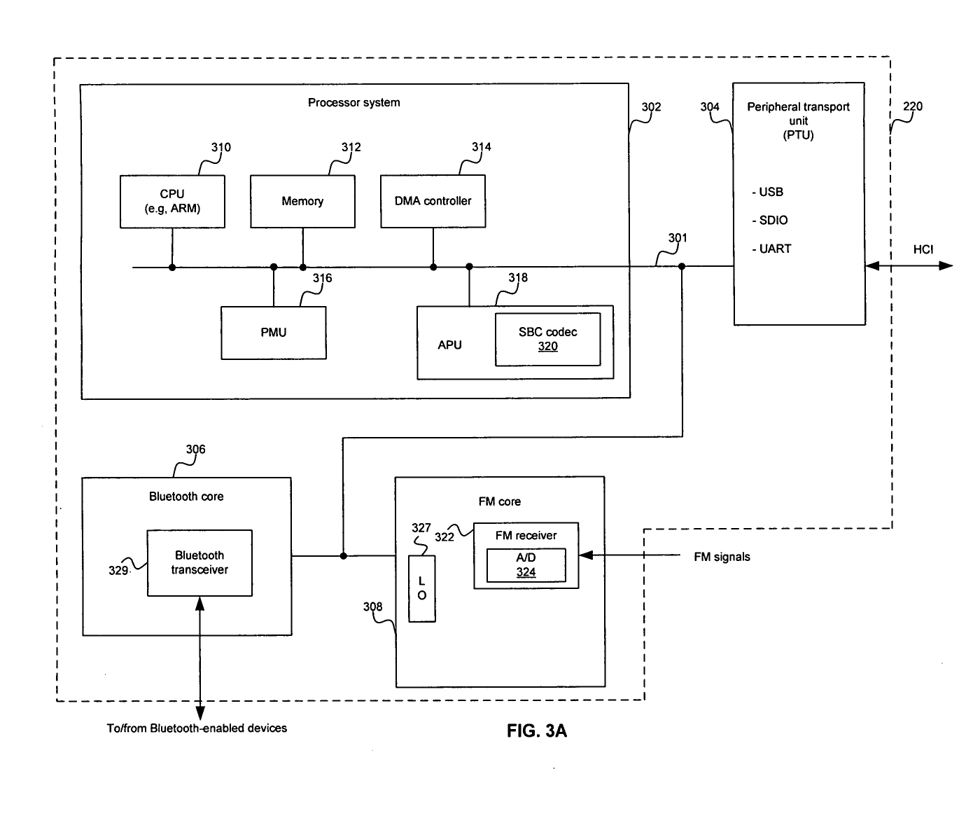

FIG. 3A is a block diagram of an exemplary Bluetooth controller with integrated Bluetooth and FM radios that supports Bluetooth and FM operations, in accordance with an embodiment of the invention. Referring to FIG. 3A, there is shown the BT-FM chip 220 that may comprise a processor system 302, a peripheral transport unit (PTU) 304, a Bluetooth core 306, a frequency modulation (FM) core 308, and a common bus 301. The BT-FM chip 220 may be implemented, for example, in a single integrated circuit, or chip. The processor system 302 may comprise a central processing unit (CPU) 310, a memory 312, a direct memory access (DMA) controller 314, a power management unit (PMU) 316, and an audio processing unit (APU) 318.

The CPU 310 may comprise suitable logic, circuitry, and/or code that may enable control and/or management operations in the BT-FM chip 220. In this regard, the CPU 310 may communicate control and/or management operations to the Bluetooth core 306, the FM core 308, and/or the PTU 304 via a set of register locations specified in a memory map. Moreover, the CPU 310 may be utilized to process data received by the BT-FM chip 220 and/or to process data to be transmitted by the BT-FM chip 220. The CPU 310 may enable processing of data received via the Bluetooth core 306, via the FM core 308, and/or via the PTU 304. For example, the CPU 310 may enable processing of received FM data to baseband FM data and may then transfer the baseband FM data to other components of the BT-FM chip 220 via the common bus 301. For example, the baseband FM data may be communicated to the host 210, where the host 210 may further process the baseband FM data, in order, for example, to play the FM music and/or information via at least one speaker 228.

The memory 312 may comprise suitable logic, circuitry, and/or code that may enable data storage. In this regard, the memory 312 may be utilized to store data that may be utilized by the processor system 302 to control and/or manage the operations of the BT-FM chip 220. The memory 312 may also be utilized to store data received by the BT-FM chip 220 via the PTU 304 and/or via the FM core 308. Similarly, the memory 312 may be utilized to store data to be transmitted by the BT-FM chip 220 via the PTU 304. The DMA controller 314 may comprise suitable logic, circuitry, and/or code that may enable transfer of data directly to and from the memory 312 via the common bus 301 without involving the operations of the CPU 310.

The PMU 316 may comprise suitable logic, circuitry, and/or code that may enable providing various levels of power to various circuitry, such as, for example, the processor system 302, as needed to conserve power. The APU 318 may comprise a subband coding (SBC) codec 320. The SBC codec 320 may be an audio coding system specially designed for Bluetooth audio and video applications to obtain high quality audio at medium bit rates, and to have a low computational complexity. The SBC codec 320 may use 4 or 8 subbands, an adaptive bit allocation algorithm, and simple adaptive block PCM quantizers.

The PTU 304 may comprise suitable logic, circuitry, and/or code that may enable communication to and from the BT-FM chip 220 via a plurality of communication interfaces. The PTU 304 may support, for example, digital communication with at least one port. For example, the PTU 304 may support at least one of a universal serial bus (USB) interface, a secure digital input/output (SDIO) interface, or a universal asynchronous receiver transmitter (UART) interface, where one of those interfaces may be utilized for Bluetooth data communication. One of these three interfaces may be used, for example, for the HCI 222 between the BT-FM chip 220 and the host 210. Accordingly, circuitry that supports transmission of data and reception of data over the HCI 222 may be referred to as HCI portion of the BT-FM chip 220.

The Bluetooth core 306 may comprise suitable logic, circuitry, and/or code that may enable reception and/or transmission of Bluetooth data. The Bluetooth core 306 may comprise a Bluetooth transceiver 329 that may perform reception and/or transmission of Bluetooth data. In this regard, the Bluetooth core 306 may support amplification, filtering, modulation, and/or demodulation operations, for example. The Bluetooth core 306 may enable data to be transferred from and/or to the processor system 302, the PTU 304, and/or the FM core 308 via the common bus 301, for example.

The FM core 308 may comprise suitable logic, circuitry, and/or code that may enable reception of FM data. The FM core 308 may comprise a FM receiver 322 and a local oscillator (LO) 327. The FM receiver 322 may comprise an analog-to-digital (A/D) converter 324. The FM receiver 322 may support amplification, filtering, and/or demodulation operations, for example. The LO 327 may be utilized to generate a reference signal that may be utilized by the FM core 308 for performing analog and/or digital operations. The FM core 308 may enable data to be transferred from and/or to the processor system 302, the PTU 304, and/or the Bluetooth core 306 via the common bus 301, for example.

Moreover, the FM core 308 may receive analog FM signals via the FM receiver 322. The FM receiver 322 may downconvert the analog FM signals to analog baseband FM signals. The A/D converter 324 in the FM receiver 322 may be utilized to convert the analog baseband FM signals to corresponding digital baseband FM data to enable processing by the FM core 308. Data received by the FM core 308 may be routed out of the FM core 308 in digital format via the common bus 301, for example. The FM core 308 may enable radio reception at various frequencies, such as, 400 MHz, 900 MHz, 2.4 GHz and/or 5.8 GHz, for example. The FM core 308 may also support operations at the standard FM band comprising a range of about 76 MHz to 108 MHz, for example.

In one exemplary embodiment of the invention, the digital baseband FM data from the FM core 308 and may transfer the digital baseband FM data to the Bluetooth core 306 via the common bus 301. The digital baseband FM data may be communicated to the host 210 via ACL packets. The host 210 may execute portions of the Bluetooth software 214a to retrieve the digital baseband FM data from the ACL packets. The digital baseband FM data may be processed to an analog signal, and the analog signal may be played via at least one speaker 228.

While some embodiments of the invention may be implemented for use with an SBC codec, the invention need not be so limited. Other codecs, such as, for example, MP2, MC may also be used with various embodiments of the invention.

FIG. 3B is a block diagram of an exemplary Bluetooth controller with integrated Bluetooth and FM radios that supports multiple interfaces, in accordance with an embodiment of the invention. Referring to FIG. 3B, there is shown a single chip 350 that supports Bluetooth and FM radio communications. The single chip 350 may comprise a processor and memory block 352, a PTU 354, an FM control and input-output (IO) block 356, a Bluetooth radio 358, a Bluetooth baseband processor 360, and an FM radio 362. A first antenna or antenna system 366a may be communicatively coupled to the Bluetooth radio 358. A second antenna or antenna system 366b may be communicatively coupled to the FM radio 362.

The processor and memory block 352 may comprise suitable logic, circuitry, and/or code that may enable control, management, data processing operations, and/or data storage operations, for example. The PTU 354 may comprise suitable logic, circuitry, and/or code that may enable interfacing the single chip 350 with external devices. The FM control and IO block 356 may comprise suitable logic, circuitry, and/or code that may enable control of at least a portion of the FM radio 362. The Bluetooth radio 358 may comprise suitable logic, circuitry, and/or code that may enable Bluetooth communications via the first antenna 366a. The FM radio 362 may comprise suitable logic, circuitry, and/or code that may enable FM reception via the second antenna 366b. The Bluetooth baseband processor 360 may comprise suitable logic, circuitry, and/or code that may enable processing of baseband data received from the Bluetooth radio 358 or baseband data to be transmitted by the Bluetooth radio 358.

The PTU 354 may support a plurality of interfaces. For example, the PTU 354 may support an external memory interface 364a, a universal asynchronous receiver transmitter (UART) and/or enhanced serial peripheral interface (eSPI) interface 364b, and a general purpose input/output (GPIO) and/or clocks interface 364c.

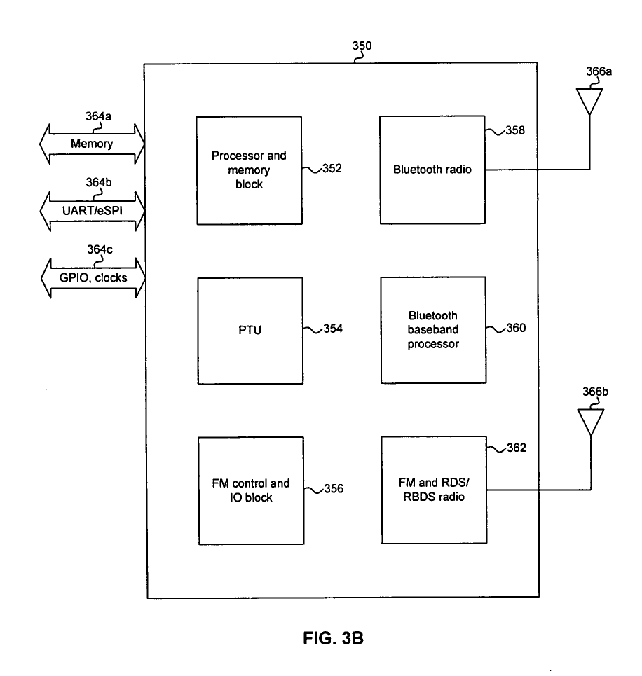

FIG. 4 is a diagram of a data packet that may be communicated across the HCI link, which may be utilized in connection with an embodiment of the invention. Referring to FIG. 4, there is shown a HCI data packet 400 comprising a packet type field 401, a connection handle field 402, a data length field 404, and a payload field 406. The packet type field 401 may be one byte in length, and different values in the field may indicate different types of packets. For example, a value of “0x01” may indicate command packet, a value of “0x02” may indicate an ACL data packet; a value of “0x03” may indicate a SCO data packet, and a value of “0x04” may indicate an event packet. Additional packet descriptions may be used for specific implementations, however, the Bluetooth protocol layers at the host and at the Bluetooth controller need to know the definition of the values associated with the packet type field 401.

The connection handle in the connection handle field 402 may indicate physical link identifier and hence specifically identify a receiver of the packet. A packet sent to the host 210 by the Bluetooth controller 220a may have the connection handle inserted by a link manager, for example, in the Bluetooth controller 220a, which may have established the link between Bluetooth devices. The connection handle may comprise 12 bits, and an additional four bits may be used to indicate a start of a new packet or continuation of a packet. Accordingly, the connection handle field 402 may comprise 16 bits, or two bytes. The data length field 404 may be two bytes in length, and hence may indicate that the data in the payload load field 406 may be as large as 64 KBs. The size of payload allowed may depend on the type of packet being sent. For example, while an ACL packet may have a payload as large as 64 KBs, a SCO packet may be limited to 255 bytes.

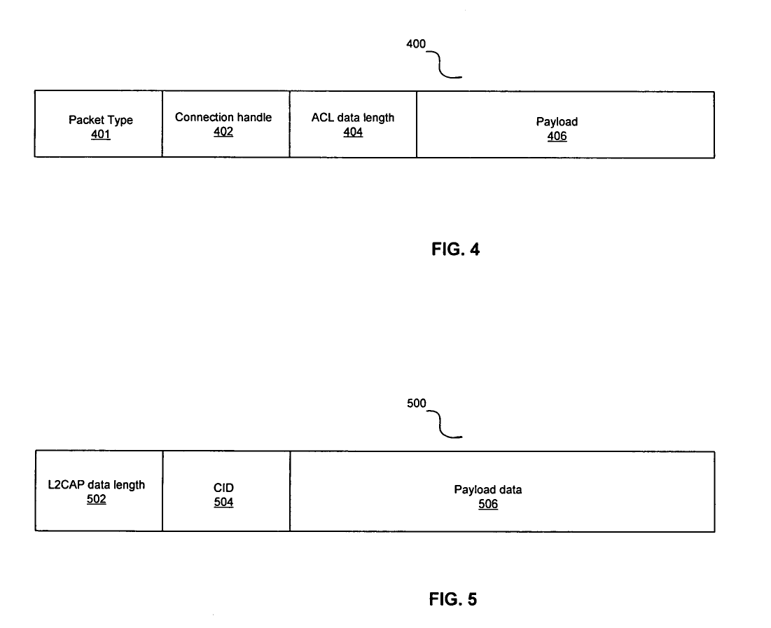

FIG. 5 is a diagram of a L2CAP data packet, which may be utilized in connection with an embodiment of the invention. Referring to FIG. 5, there is shown a L2CAP packet 500 comprising a L2CAP data length field 502, a channel ID field 504, and a L2CAP payload field 506. The L2CAP packet 500 may be the payload in the payload field 406 of the HCI data packet 400. The L2CAP data length field 502 may be two bytes in length, and may indicate a L2CAP payload size of up to 64 KB minus four bytes. The channel ID (CID) field 504 identifies the logical link to be used, which may be specified by higher layer software. The data in the payload data field 506 may be data that may need to be communicated from one Bluetooth device to another, from a Bluetooth controller to the host, or from the host to the Bluetooth controller.

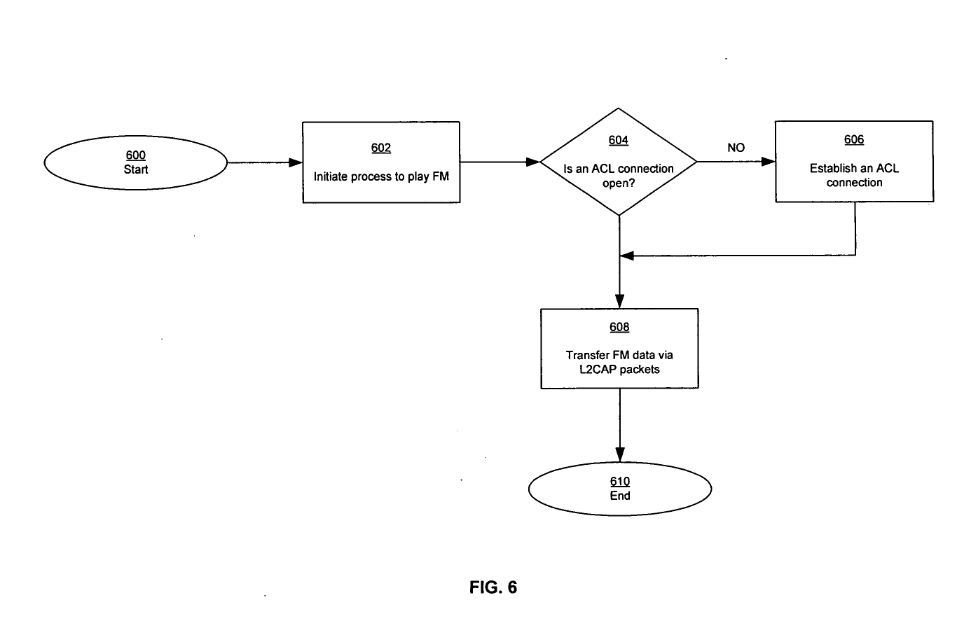

FIG. 6 is a flow diagram that illustrates exemplary steps for initiating transfer of digital baseband FM data via the HCI link, in accordance with an embodiment of the invention. Referring to FIG. 6, there is shown steps 600 to 610. In step 602, after the start step 600, a user may initiate a process to listen to FM broadcast on a Bluetooth enabled device, for example. In step 604, the host 210 may determine whether there is already an ACL connection between the host 210 and the Bluetooth controller 220a. If there is an ACL connection open, the next step may be step 608. Otherwise, the next step may be step 606.

In step 606, the host 210 may open an ACL connection via the HCI 222. In step 608, the Bluetooth controller 220a may transfer FM data via HCI packets to the host 210. The FM data may be digital baseband FM data, and a HCI packet may comprise a L2CAP packet, for example. The host 210 may process the digital baseband FM data according to the determined parameters. The processing may also comprise converting the digital baseband FM data to analog signals via the DAC 226. The converted analog signals may then be played via at least one speaker 228. The next step may be the end step 610, which may be, for example, an idle step where further input is required. For example, a user may terminate the process of playing FM broadcast signals, and the host may tear down the ACL link used for transfer of digital baseband FM data. Alternatively, the ACL link may be left open for future use.

In an embodiment of the invention, a packet type may be defined for the packet type field 401. The baseband FM data sent in packets via a link established across the HCI 222 may comprise, for example, various parameters. For example, the parameters may indicate the sampling rate per second, the number of bits per sample, what type of compression, if any, is used, whether the samples alternate from left channel to right, or vice versa, or whether the entire packet is for left channel samples or right channel samples.

The parameters may be determined between the host 210 and the Bluetooth controller 220a. Additionally, default parameter values may be used if the parameters are not determined prior to transmission of digital baseband FM data. For example, each sample may be 16 bits at 48 kilo-samples per second, and the samples may be compressed. Other default parameters may be that the packet comprises samples that alternate from the left channel to the right channel, with the first sample being a left channel sample, followed by a right channel sample, and there may be an equal number of left channel samples as right channel samples.

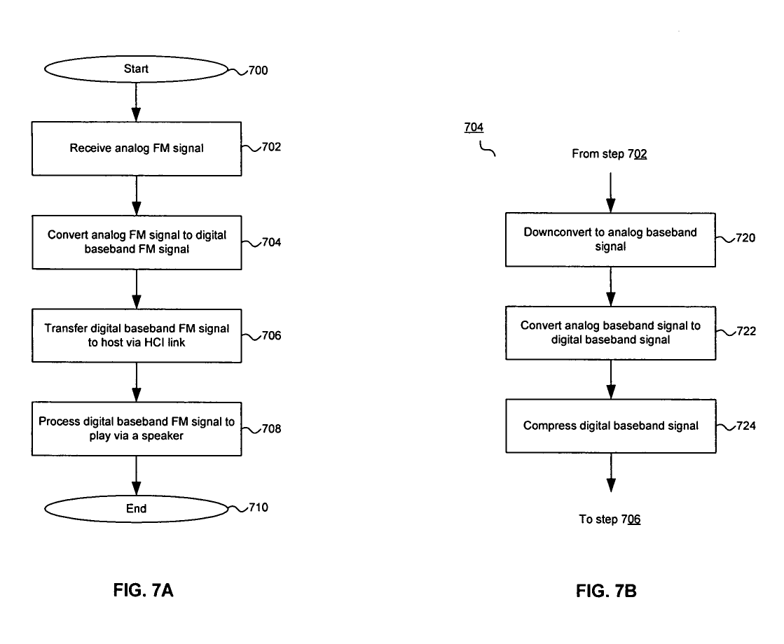

FIG. 7A is a flow diagram that illustrates exemplary steps for communicating digital baseband FM data via the HCI link, in accordance with an embodiment of the invention. Referring to FIG. 7A, there is shown steps 700 to 710. In step 702, after the start step 700, the FM signal may be received by, for example, the FM receiver 322. In step 704, the FM receiver 322 may convert the analog baseband FM signal to corresponding digital baseband FM signal. In step 706, the digital baseband FM signal may be communicated to the host 210 via a link over the HCI 222. In step 708, the host 210 may process the digital baseband FM signal, via the DAC 226, for example, to generate an analog signal, which may be played via at least one speaker 228. The next step may be the end step 710.

FIG. 7B is a flow diagram that illustrates exemplary steps for converting received FM signals to digital baseband FM data, in accordance with an embodiment of the invention. Referring to FIG. 7B, there is shown steps 720 to 724, which may be steps that comprise the step 704. In step 720, which may occur after the step 702, the received analog FM signal may be downconverted from RF frequencies to baseband frequencies to generate an analog baseband FM signal.

In step 722, the analog baseband FM signal may be converted to a digital baseband FM data via, for example, the ADC 324. The sampling rate of the ADC 324 may be at least twice the highest frequency desired in the analog signal. For example, since commercial FM broadcasts have an upper frequency limit of 15 KHz, the sampling rate may be 30,000 samples per second or greater. Accordingly, the sampling rate may be, for example, 32 Kbps or 48 Kbps. The fidelity of the analog signal reproduced from the digital samples may also depend on the number of bits in each digital sample. Accordingly, each sample may comprise, for example, 16 bits. The sampling rate and/or bits per sample may be parameters that may be determined by a user, or it may be design and/or implementation dependent.

In step 724, the digital baseband FM data may be compressed in order to reduce bandwidth needed to communicate the digital baseband FM data to the host via the HCI 222. The data may be compressed by, for example, the SBC codec 320. Other compression schemes, such as, for example, MP3 encoding, may also be used. A user for the mobile terminal 200 may choose the amount of compression, or the compression may be fixed depending on design and/or implementation. The next step may be step 706.

In accordance with an embodiment of the invention, aspects of an exemplary system may comprise a Bluetooth controller 220a and the FM radio 220b integrated into a single chip, for example, the BT-FM chip 220. The Bluetooth controller 220a may communicate with the host 210 via links established over the HCI 222. There may be circuitry, such as, for example, at least a portion of the PTU 304, which may be associated with the HCI 222. The FM radio 220b may process received FM signals and generate corresponding digital baseband data. The digital baseband data may be communicated to the Bluetooth controller 220a, and the Bluetooth controller 220a may communicate the digital baseband data to the host 210 via the HCI 222. The digital baseband data may comprise samples of a left channel signal and a right channel signal from, for example, the ADC 324. The sampling rate of the ADC 324 may be at least 30 kilo-samples per second, such as, for example, 32 kilo-samples per second or 48 kilo-samples per second.

The digital baseband signals may be communicated to the host 210 via a L2CAP link over the HCI 220. The Bluetooth controller 220a may alternate placing the left channel signal samples and the right channel signal samples in each L2CAP packet. The Bluetooth controller 220a may notify the host 210 whether the left channel signal sample or the right channel signal sample is placed first. If the Bluetooth controller 220a places all of the right channel signal samples before the left channel signal samples in each L2CAP packet, or vice versa, the Bluetooth controller 220a may notify the host 210 which channel samples are placed first. The Bluetooth controller 220a may place an equal number of the left channel signal samples and the right channel signal samples in each L2CAP packet. The Bluetooth controller 220a may also comprise circuitry, for example, the SBC codec 320, which may compress the left channel signal samples and the right channel signal samples. Accordingly, the Bluetooth controller 220a may communicate compressed digital baseband signals to the host device via the HCI interface.

Another embodiment of the invention may provide a machine-readable storage, having stored thereon, a computer program having at least one code section executable by a machine, thereby causing the machine to perform the steps as described above for transporting FM data over a Bluetooth HCI link.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing wireless communication, the method comprising:
processing received FM signals in a single chip comprising an integrated Bluetooth radio, an integrated FM radio, and a host-controller interface; and
communicating said processed received FM signals via said host-controller interface to a host device communicatively coupled to said single chip.

2. The method according to claim 1, wherein said processed received FM signals comprise digital baseband signals.

3. The method according to claim 2, wherein said digital baseband signals comprise samples of a left channel signal and samples of a right channel signal.

4. The method according to claim 3, wherein said communication of said digital baseband signals occur via a L2CAP connection.

5. The method according to claim 4, comprising alternating said left channel signal samples with said right channel signal samples in each L2CAP packet.

6. The method according to claim 4, comprising notifying said host device whether said right channel signal samples are placed before said left channel signal samples in said each L2CAP packet.

7. The method according to claim 4, comprising communicating an equal number of said left channel signal samples and said right channel signal samples in said each L2CAP packet.

8. The method according to claim 3, comprising compressing said left channel signal samples and said right channel signal samples.

9. The method according to claim 1, comprising compressing said processed received FM signals prior to communicating via said host-controller interface to said host device.

10. A machine-readable storage having stored thereon, a computer program having at least one code section for wireless communication, the at least one code section being executable by a machine for causing the machine to perform steps comprising:
processing received FM signals in a single chip comprising an integrated Bluetooth radio, an integrated FM radio, and a host-controller interface; and
communicating said processed received FM signals via said host-controller interface to a host device communicatively coupled to said single chip.

11. The machine-readable storage according to claim 10, wherein said processed received FM signals comprise digital baseband signals.

12. The machine-readable storage according to claim 11, wherein said digital baseband signals comprise samples of a left, channel signal and samples of a right channel signal.

13. The machine-readable storage according to claim 12, wherein said communication of said digital baseband signals occur via a L2CAP connection.

14. The machine-readable storage according to claim 13, comprising code for alternating said left channel signal samples with said right channel signal samples in each L2CAP packet.

15. The machine-readable storage according to claim 13, comprising code for notifying said host device whether said right channel signal samples are placed before said left channel signal samples in said each L2CAP packet.

16. The machine-readable storage according to claim 13, comprising code for communicating an equal number of said left channel signal samples and said right channel signal samples in said each L2CAP packet.

17. The machine-readable storage according to claim 12, comprising code for compressing said left channel signal samples and said right channel signal samples.

18. The machine-readable storage according to claim 10, comprising code for compressing said processed received FM signals prior to communicating via said host-controller interface to said host device.

19. A system for providing wireless communication, the system comprising:
a single chip comprising an integrated Bluetooth radio, an integrated FM radio, and a host-controller interface that enables processing of received FM signals; and
said single chip enables communication of said processed received FM signals to a host device communicatively coupled via said host-controller interface.

20. The system according to claim 19, wherein said processed received FM signals comprise digital baseband signals.

21. The system according to claim 20, wherein said digital baseband signals comprise samples of a left channel signal and samples of a right channel signal.

22. The system according to claim 21, wherein said communication of said digital baseband signals occur via a L2CAP connection.

23. The system according to claim 22, wherein said single chip comprises a Bluetooth controller that enables alternately placing said left channel signal samples and said right channel signal samples in each L2CAP packet.

24. The system according to claim 22, wherein said single chip comprises a Bluetooth controller that enables notifying said host device whether said right channel signal samples are placed before said left channel signal samples in said each L2CAP packet.

25. The system according to claim 22, wherein said single chip comprises a Bluetooth controller that enables placing an equal number of said left channel signal samples and said right channel signal samples in said each L2CAP packet.

26. The system according to claim 21, wherein said single chip comprises circuitry that enables compression of said left channel signal samples and said right channel signal samples.

27. The system according to claim 19, wherein said single chip comprises circuitry that enables compression of said processed received FM signals prior to communicating via said host-controller interface to said host device.
